(19) United States
(12) Patent Application Publication
(10) Pub. No.: US 2014/0035779 A1
(43) Pub. Date: Feb. 6, 2014

(54) Highly accurate calibration of microwave radiometry devices

(71) Applicant: Fredrick S. Solheim, Boulder, CO (US)

(72) Inventor: Fredrick S. Solheim, Boulder, CO (US)

(73) Assignee: Radiometrics Corporation

(21) Appl. No.: 13/507,823

(22) Filed: Jul. 31, 2012

(51) Int. Cl. G01S 7/40

(52) U.S. Cl. 342/174

(57) ABSTRACT

Systems and methods are disclosed for highly accurate calibration of microwave radiometry devices by defeating reflections from a cryogenic blackbody calibration target and, further, defeating a standing wave established between reflecting features at the device and at the blackbody calibration target. The preferred disclosed system includes adaptations for effective Brewster angle presentation of radiation emanating from the target to the radiometry device. Other embodiments are taught for substantially eliminating or randomizing the standing wave in both wavelength dependent and independent applications.

### FIELD OF THE INVENTION

This invention relates to microwave radiometry device calibration, and, more particularly, relates to systems and methods for remote calibration of portable, fixed or laboratory radiometry devices utilizing a cryogenic target.

### BACKGROUND OF THE INVENTION

It is a problem in the fields of microwave radiometry and microwave metrology to have a highly accurate reference cold target for gain and offset calibration of microwave measurement equipment. Liquid cryogens such as liquid nitrogen are often utilized because they offer a calibration temperature in the region of the desired radiometer measurements. The attractiveness of cryogenic targets is that their physical temperatures can be very accurately known as a function of barometric pressure because they are at their boiling point, and additionally, the temperatures of these targets are generally in the vicinity of or span the regions of interest in the temperature domain.

It is desirable that such a reference target be small but scalable, portable, and easy to implement. Such a target is taught in U.S. Pat. No. 5,526,676. This target has an advantage over a number of difficulties and deficiencies of cryogenic targets that are viewed from above (such as the National Institute of Science and Technology 10 GHz noise reference and other implementations of that manner) wherein the surface of the blackbody emitter is not fully saturated with the cryogen and is therefore influenced by radiation incident from the environment of the emitter, or if fully wetted, suffer reflection of the environment at the surface of the cryogen. Additionally, atmospheric gases in such implementations can liquefy into the liquid nitrogen and raise the liquid temperature an unknown amount, and water vapor can form a cloud of ice crystals over the cryogen, occluding the view of the target and causing an error.

But the calibration target taught in U.S. Pat. No. 5,526,676 also has a number of deficiencies that degrade its accuracy. These deficiencies include the reflection of the target environment from the bottom surface of the liquid cryogen in the target, and errors due to the standing wave between the bottom surface of the cryogen and reflective features in the radiometer antenna system in the antenna path. The reflective features can include the reflection coefficient of the feed horn, the antenna isolator, the antenna PIN switch, the RF port of the mixer, the input port to the first amplifier, the dielectric phase correcting lens at the antenna, and/or other reflecting features in the antenna system. If the lens has a flat surface toward the cryogen surface and oriented parallel to the cryogen surface, this standing wave can be of large amplitude. Other deficiencies, such as condensation of moisture on the external surfaces of the target, also add to or subtract from the observed target blackbody temperature by an uncertain amount.

VSWR stands for Voltage Standing Wave Ratio, and is also referred to a Standing Wave Ratio (hereinafter SWR). SWR is a function of the reflection coefficients, and describes the power reflected between the antenna and another reflector. If the reflection coefficient is give by r, the SWR is defined as:

SWR=(1+|r|)/(1−|r|)

The SWR is always a real and positive number for antenna systems. The smaller the SWR is, the better the antenna is matched to transmission line and the more power is delivered to or from the antenna. The minimum SWR is 1.0, in which case no power is reflected from the antenna, which is ideal.

Fresnel's Equations state that the amplitude of the orthogonal reflection from the interface between two dielectrics of refractive index n₁ and n₂ is:

Eᵣ₌₍nᵣ−n₂)Ei/(n₁₁+n₂)

In the case of liquid nitrogen being implemented as the target cryogen, this reflection can contribute as much as 2K to the observed target temperature. A standing wave can exist between the bottom surface of the liquid nitrogen and the radiometer antenna system, raising or lowering the expected observed temperature. Depending upon the antenna system reflection, this standing wave can offset the true target blackbody temperature by 10's of Kelvins.

The target can cold soak and liquid cryogen and cool cryogen gas can penetrate the interstitial areas of the dielectric foam cooler, cooling the underside of the polystyrene or similar container, condensing water vapor into liquid water on the lower surface of the container. Reference FIG. 1. This liquid water will raise the observed target temperature, as it is a strong absorber/emitter of microwave radiation.

While solutions have heretofore been suggested (see, for example, U.S. Pat. Nos. 3,778,837 and 5,526,676), these have been less than optimal. Further improvement could thus still be utilized in such reference target systems.

### SUMMARY OF THE INVENTION

This invention includes systems and methods for highly accurate calibration of microwave radiometry devices of the type having an antenna window protecting internal mechanisms such as phase lens/antenna components. The systems of this invention include a target container for holding a blackbody target therein. The target (an immersed blackbody material immersed in a cryogen), when located in the container, and the lens/antenna component establish reflecting features which present a standing wave therebetween when the container is located at the window of the radiometry device for calibration of the device. To address the deleterious effects of the standing wave and reflections from the target, the systems of this invention include means at one of the container and the radiometry device for defeating the standing wave when the container is located at the radiometry device for calibration of the device. In the preferred embodiments of this invention, this is by effective Brewster angle presentation of radiation emanating from the target to the radiometry device. This preferred embodiment also eliminates the reflection of ambient environment from the adjacent (lower typically) surface of the liquid nitrogen into the antenna system.

The methods of this invention thus include steps for holding the blackbody target in the target container and mounting the container in a selected orientation relative to the radiometry device. The standing wave presented between the reflecting features and the reflection of the ambient environment are defeated by effective Brewster angle presentation of radiation emanating from the target to the radiometry device.

This invention provides systems and methods that overcome a number of uncertainties in blackbody temperature and difficulties in implementation that are difficult to characterize and correct, by either randomizing the deleterious effects of the standing wave and reference target reflections or, preferably, by nearly eliminating these effects.

It is therefore an object of this invention to provide improved calibration systems and methods for microwave radiometry devices.

It is another object of this invention to provide improved calibration systems and methods for microwave radiometry devices that overcome a number of uncertainties in blackbody temperature and difficulties in implementation that are difficult to characterize and correct.

It is still another object of this invention to provide radiometry device calibration systems and methods that overcome uncertainties in blackbody temperature and difficulties in implementation by randomizing or nearly eliminating the deleterious effects of standing waves and reference target reflections.

It is another object of this invention to provide a highly accurate calibration system for a microwave radiometry device having an antenna window and a first reflecting feature thereat, the system including a target container for holding a blackbody target therein, the target having a second reflecting feature when located in the container, the first reflecting feature and the second reflecting feature presenting a standing wave therebetween when the container is located at the window of the radiometry device for calibration of the device, and means at one of the container and the radiometry device for effective Brewster angle presentation of radiation emanating from the target to the radiometry device for defeating the standing wave.

It is still another object of this invention to provide a highly accurate calibration system for a microwave radiometry device having a first reflecting feature thereat, the system including a target container for holding a blackbody target, the target having a second reflecting feature when located in the container, and means at one of the container and the radiometry device for defeating a standing wave presented between the first reflecting feature and the second reflecting feature when the container is located at the radiometry device for calibration of the device.

It is yet another object of this invention to provide a highly accurate calibration method for microwave radiometry devices that includes the steps of holding a blackbody target in a target container, mounting the container in a selected orientation relative to the radiometry device, and defeating a standing wave presented between a first reflecting feature at the radiometry device and a second reflecting feature at the blackbody target in the container when the container is mounted at the radiometry device for calibration of the device by effective Brewster angle presentation of radiation emanating from the target to the radiometry device.

With these and other objects in view, which will become apparent to one skilled in the art as the description proceeds, this invention resides in the novel construction, combination, and arrangement of parts and methods substantially as hereinafter described, and more particularly defined by the appended claims, it being understood that changes in the precise embodiment of the herein disclosed invention are meant to be included as come within the scope of the claims.

### BRIEF DESCRIPTION OF THE DRAWINGS

The accompanying drawings illustrate a complete embodiment of the invention according to the best mode so far devised for the practical application of the principles thereof, and in which:

FIG. 1 is a side elevation view of a cryogenic calibration system of this invention located on an exemplary radiometry device;

FIG. 2 is a sectional view of a prior art radiometry device provided for background;

FIG. 3 is a diagrammatic illustration of the device of FIG. 2 to provide further background;

FIG. 4 is a perspective view of the system and device in FIG. 1;

FIG. 5 is an end view of the system and device in FIG. 1 with the system dismounted;

FIG. 6 illustrates a first preferred embodiment of the application of the cryogenic calibration system of this invention;

FIG. 7 illustrates a second preferred embodiment of the application of the cryogenic calibration system of this invention

FIG. 8 illustrates a third embodiment of this invention utilizing an impedance matching layer;

FIG. 9 illustrates a forth embodiment of this invention utilizing an impedance matching corrugations feature;

FIG. 10 illustrates a fifth embodiment of this invention utilizing matching corrugations of on or adjacent to the antenna system phase correcting lens;

FIG. 11 illustrates a sixth embodiment of this invention utilizing an impedance matching layer on or adjacent to the antenna system phase correcting lens;

FIG. 12 illustrates a seventh embodiment of this invention showing a method of minimization of standing wave effects by creating anti-parallel reflections;

FIG. 13 illustrates an eighth embodiment of this invention showing a method of minimization of standing wave effects by canting the cryogen lower surface to create anti-parallel reflections; and

FIG. 14 illustrates a ninth embodiment of this invention showing a method of randomizing standing wave effects by provision of an undulating lower surface of the cryogen container.

### DESCRIPTION OF THE INVENTION

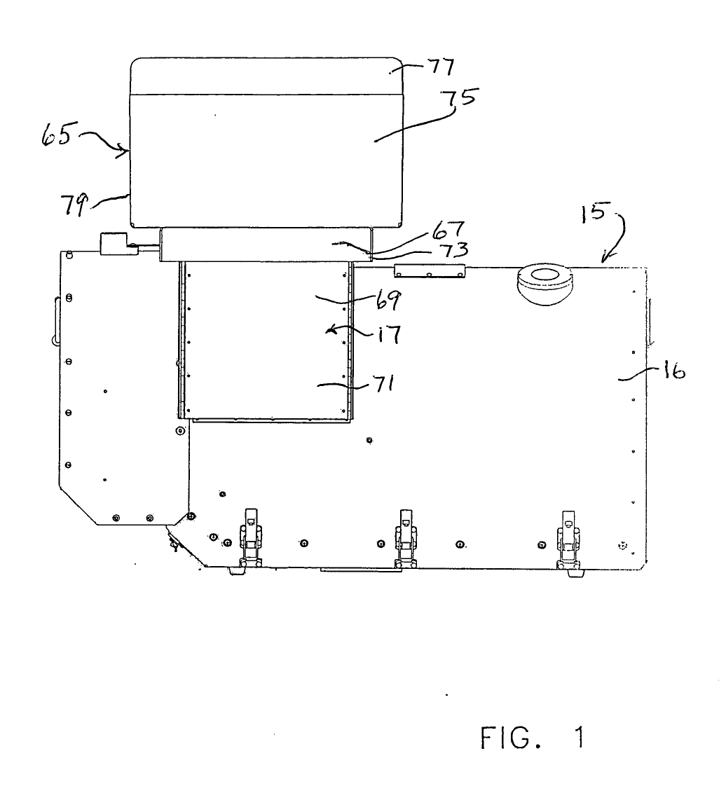

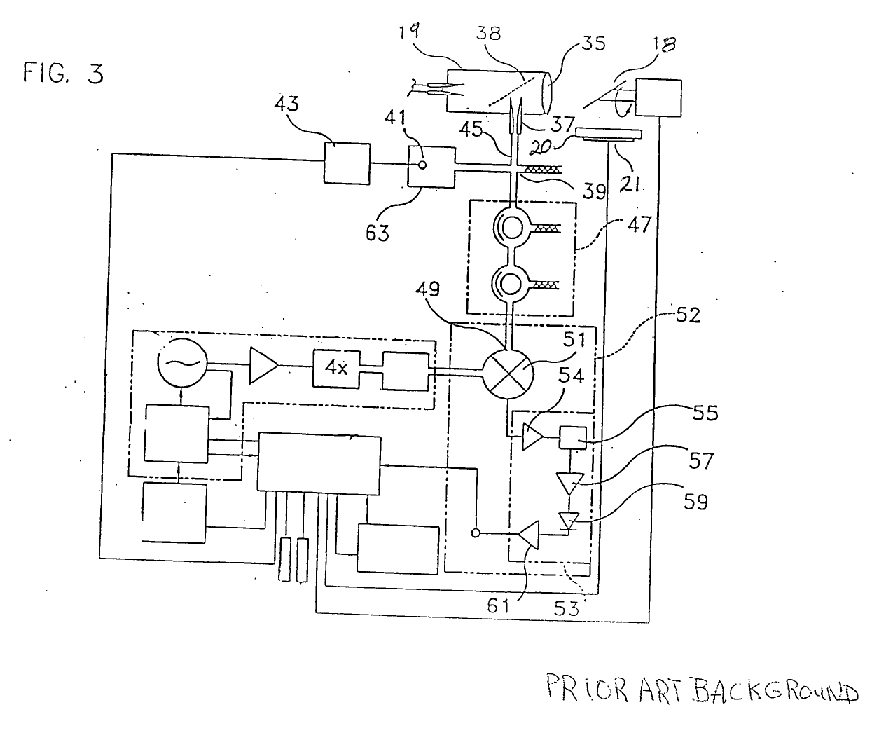

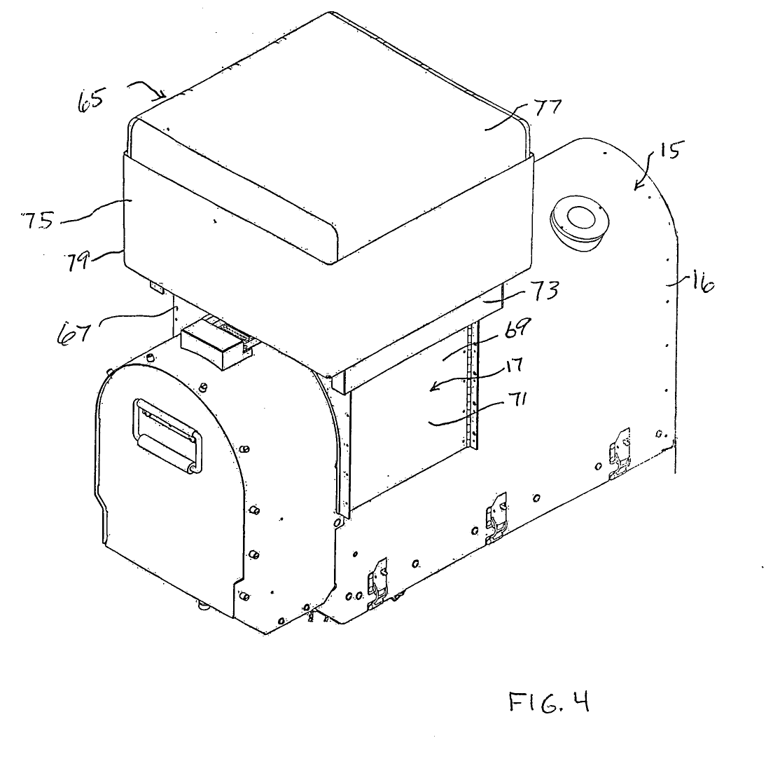

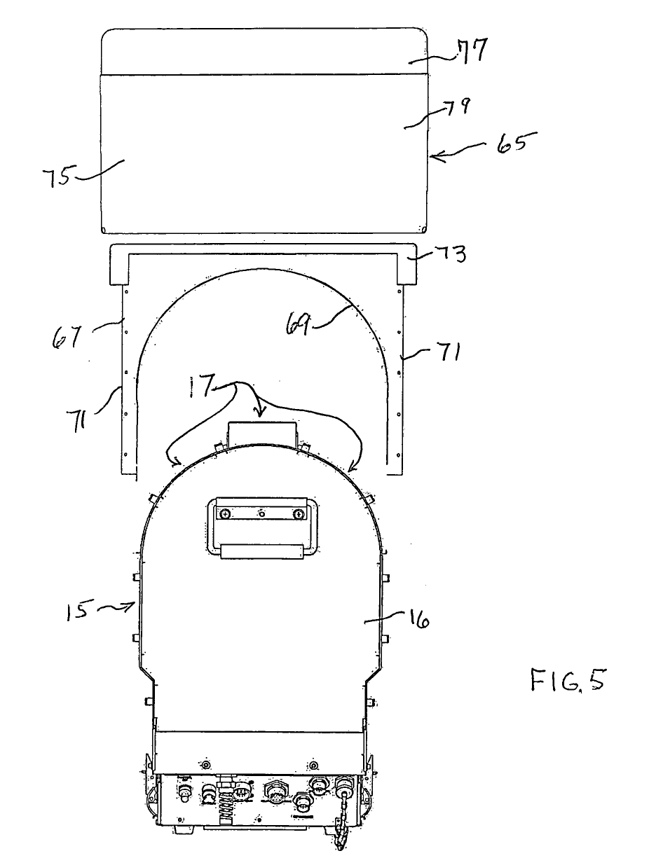

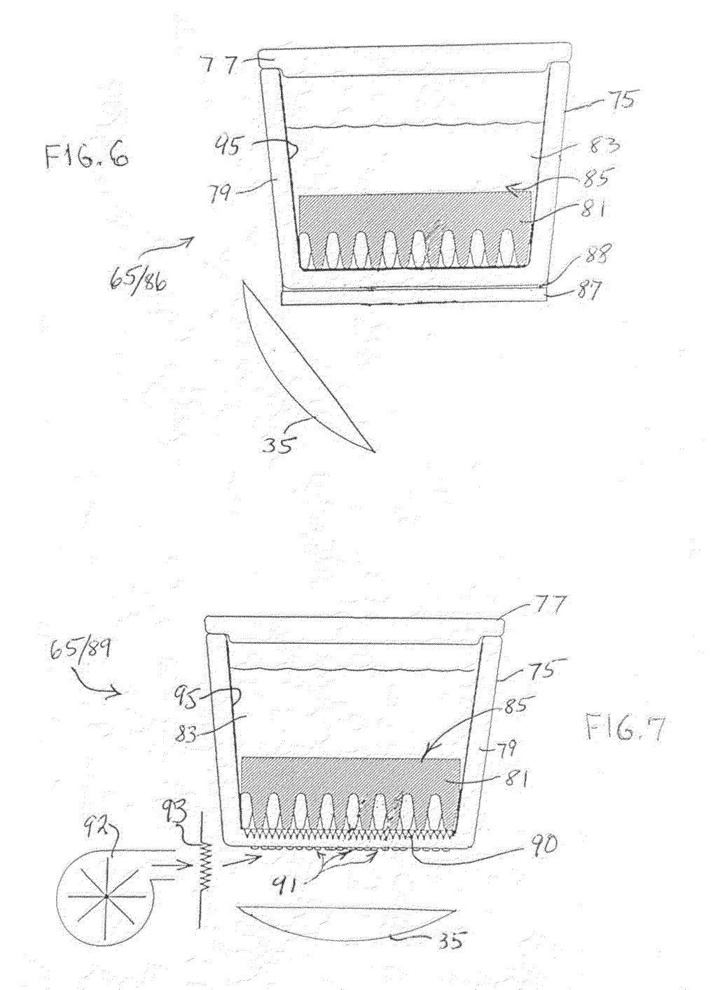

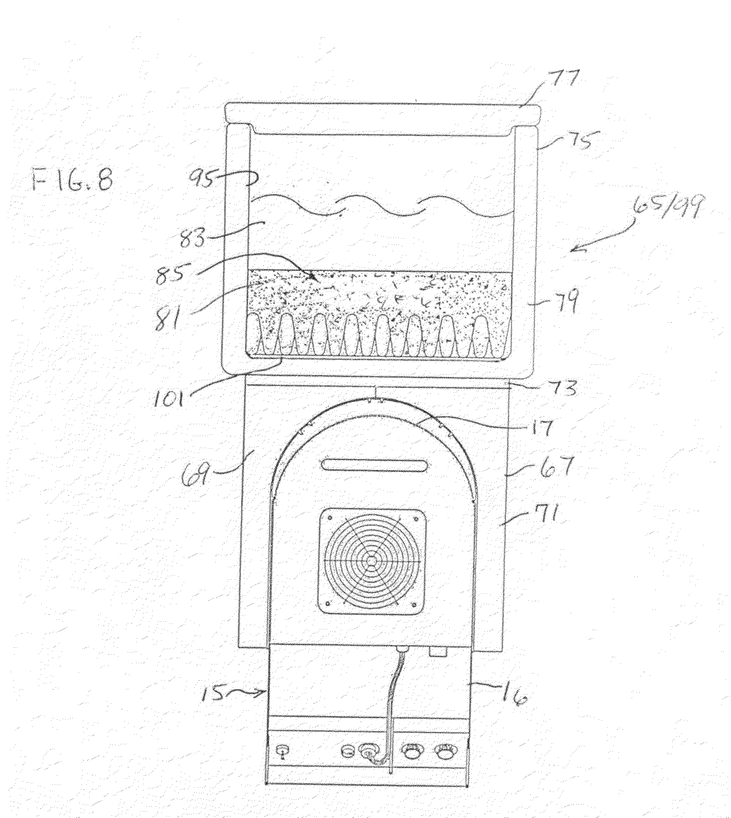

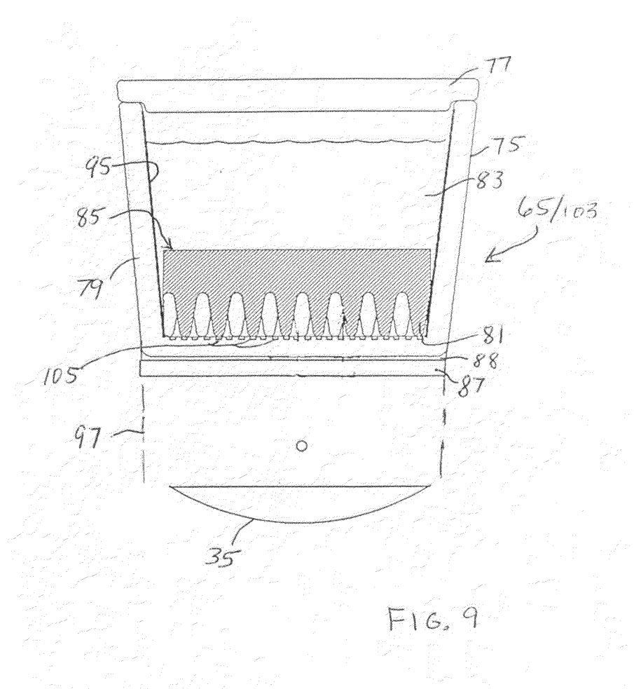

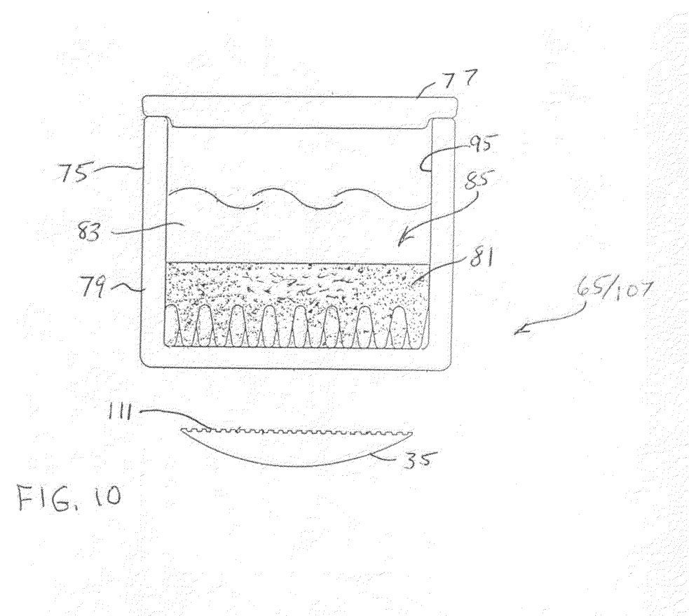

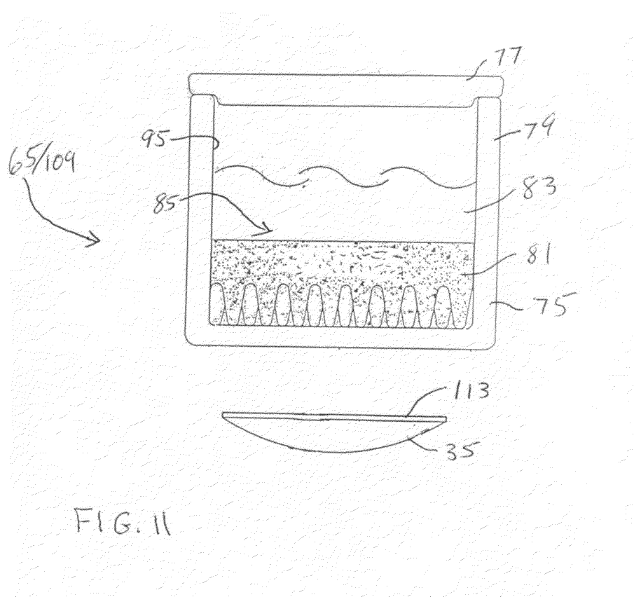

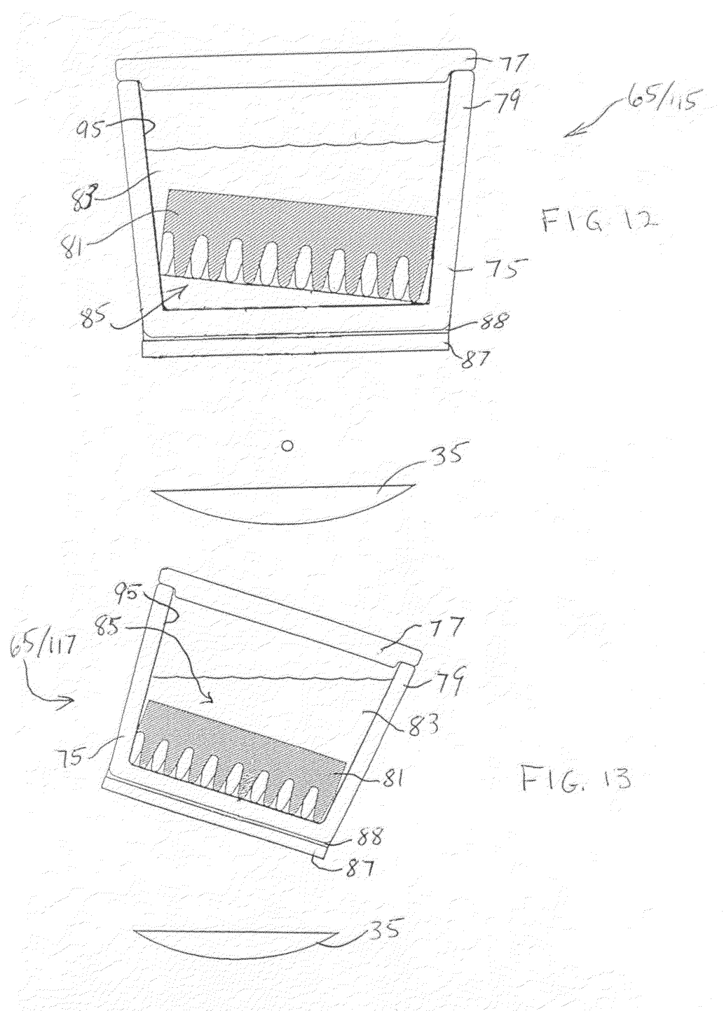

As background, a radiometry device typically may be configured as illustrated in FIGS. 1 through 3 (showing a known radiometer 15). Radiometry device 15 shown herein for purposes of illustration of the calibration system of this invention, may be a highly accurate yet portable device utilized, for example, for atmospheric profiling, measurement of physical parameters of the Earth's surface or other passive emission measurements. Such a device will typically include a passive microwave receiver system, also called a passive microwave radiometer that can determine profiles of various physical parameters of the atmosphere over a plurality of selected altitudes to a high degree of accuracy. The profile measurements are accomplished by a series of observations of the sky at different frequencies and/or different elevation angles of observation, and require accurate periodic device calibration to maintain accuracy.

As is known, such a microwave radiometry device 15 includes an instrument housing 16 having an antenna system with an antenna window 17 thereat. For use in a radiometer, window 17 (a radome having both an upper surface and lateral, or side, surfaces at each side of housing 16) is preferably formed from material which is nearly transparent to the broad band microwave signals of interest (TEFLON, for example). The window (or “dielectric window”) is utilized to protect the actual antenna of the instrument and may be any of various types (dielectric windows, covers, protective films, fabrics and the like) made of known materials utilized in construction thereof (though non-conductive materials are most typical and clearly intended when the term “dielectric” is utilized).

Radiometry device 15 includes mirror 18 steerable to point to all elevation angles (for off-zenithal observations) and directional angles (for azimuthal observations) and thus to all sky vectors. When pointed downward, the field of view of antenna 19 is filled with blackbody 20 of a known temperature as determined and updated by reference to temperature sensor 21. Observing blackbody 20 establishes the receiver offset. When pointed upward through a window in the housing, atmospheric emissions having frequencies of interest are received and observed, side lobe collar 23 provided to reduce or negate effects of antenna side lobes. Standard control computer (a PC for example) and power connectors are provided.

Antenna 19, having lens 35 thereat, includes corrugated feed horn 37 receiving microwave emissions, and thus the frequencies of interest, as focused by lens 35. Antenna 19, where multiple receivers are used, may include signal splitter 38.

Directional coupler 39 injects signal of known equivalent temperature from stabilized noise diode 41 connected with driver 43 into antenna waveguide 45 when the noise diode is on. Measuring the contribution of the injected signal to the receiver output establishes the gain of the receiver. The passive radiometer can be constructed with waveguide of predetermined size, or can be constructed utilizing other known methods.

Coupler 39 is followed by isolator 47 to prevent local oscillator leakage from RF port 49 of mixer 51 from exiting and re-entering antenna 19 as an error source, and to minimize the reflection at the mixer RF port back out of the antenna system. Downconversion system 52, including biased mixer 51, is followed by signal conditioning system 53 having amplification stage 54, IF filtering stage 55, further amplification stage 57, detection by square law detector 59, and amplification stage 61. All the foregoing, as well as the remaining illustrated components, is standard in a device of this type.

The accuracy of the radiometer receiver is dependent upon the stability and resolving power of the receiver and of the stability of the noise diode gain reference. To increase the stability of noise diode 41, its mount 63 is held at a constant temperature. As may be appreciated, with such a high degree of accuracy desired and anticipated by design features of the device, proper and accurate device calibration must be maintained.

Turning now to FIGS. 1, 4 and 5, basic housing and mounting structures of calibration system 65 of this invention (all embodiments) will be described. Saddle 67 includes mount 69 having side walls 71 configured to cover and seal the entire surface area of window 17 of radiometry device 15. Saddle 67 also includes platform 73 for receiving target container 75 thereat. Saddle 67 is structured overall so that container 75 is selectively oriented relative to device 15 when located in or on saddle 67. Container 75 includes a removable lid, or cap, 77 securely receivable at container body 79 for securement of the contents of container 75 therein (blackbody absorber foam material 81 of standard material and construction and, when filled, liquid nitrogen 83 together comprising blackbody target 85—see FIG. 8 for example). The container body and lid are preferably made of polystyrene or other low-loss dielectric foams. Blackbody material 81 is an open cell carbon loaded broadband microwave absorbing foam such as Cuming Corporation C-RAM RFA. The polystyrene container is by known manufacturers (for example, manufactured by ThermoSafe with interior dimensions 12″×12″×6″ or other size selected to fully accommodate the field of view of the radiometer antenna system). When blackbody target 85 is established in container 75, a reflecting feature is formed at the bottom surface of the cryogen 83 (where blackbody target 85 rests at the bottom of container 75).

This invention offers a number of embodiments and methods that, when implemented alone or in concert, remove the above-referenced calibration uncertainties and difficulties. These embodiments/methods of system 65 fall into two categories of systems for defeating the standing wave between target 85 reflecting features (as noted, at the bottom surface of container 85 in the embodiments shown herein) and radiometry device 15 reflecting features (i.e., the reflection coefficient of the feed horn, the antenna isolator, the antenna PIN switch, the RF port of the mixer, the input port to the first amplifier, the dielectric phase correcting lens at the antenna, and/or other reflecting features in the antenna system). Those categories are: systems that nearly eliminate the deleterious effects of the standing wave; and those systems that randomize the deleterious effects of the standing wave. Both categories may also include means for negating or reducing reference target reflections. The reflecting features of concern in a typical target/radiometry device calibration interface are the nearest surface of the cryogen 83 target 85 (bottom surface is illustrated herein) and lens 35/antenna 19 of device 15. Preferred embodiments and methods of calibration system 65 are illustrated in FIGS. 6 and 7 showing those aspects of this invention that nearly eliminate the deleterious effects of the standing wave in a wavelength independent implementation.

By Snell's Law, the angle of incidence at a dielectric interface is related to the angle of refraction by:

By Fresnel's Equations, the reflected amplitudes depend upon polarization relative to the plane of the incident and reflected waves, and are described as:

$${E}_{r} = \frac{sin ( {φ}_{1} - {φ}_{2} )}{sin ( {φ}_{1} + {φ}_{2} )} {E}_{i}$$

for the polarization perpendicular to the plane of incidence where Eᵢ and Eᵣ are the incident and refracted amplitudes and F₁ and F₂ are the incident and refracted angles, and

$${E}_{r} = \frac{tan ( {φ}_{1} - {φ}_{2} )}{tan ( {φ}_{1} + {φ}_{2} )} {E}_{i}$$

for the polarization parallel to the plane of incidence. Note that when

$${φ}_{1} = {tan}^{- 1} ( \frac{{n}_{2}}{{n}_{1}} ) ,$$

the amplitude of the reflected wave is zero, and there is complete transmission of the incident wave into the medium, and the error due the reflected environment is eliminated. This angle is called the Brewster angle.

While randomization of the standing wave utilized in other embodiments of this invention (shown in FIGS. 12 through 14) can average this error to zero, it will not address the contribution due to the reflection of radiation of the environment from the dielectric interface of the liquid cryogen and the container. This contribution is approximately 1.8K for reflections of an ambient environment at 300 k (+27 C) from the interface with liquid nitrogen. In order to attain the highest accuracy of the measurement of the radiometric temperature of the cryogenic target, the contribution due to these reflections must be accurately known, a difficult task, or must be eliminated. The preferred embodiments of the invention as shown in FIGS. 6 AND 7 eliminate, or nearly so, this reflection.

In both cases, means are established for effective Brewster angle presentation of radiation emanating from cryogenic target 85 to the radiometry device to defeat the standing wave. In the first of these two frequency independent embodiments shown in FIG. 6 (embodiment 86), cryogenic target 85 is viewed by radiometry device 15 at the Brewster angle. Lens 35 (of antenna 19) is configured to observe blackbody target 85 and radiation emanating therefrom at the Brewster angle at each polarization of the electromagnetic radiation. For liquid nitrogen, this angle is about 50° from orthogonal. Further benefit is achieved by adding insulating layer 87 of low loss material such as PE foam with an air gap 88 between the underside of container 75 and insulating layer 87 as a thermal break of heat conduction (while not shown in all cases, the benefits of this feature can be utilized in the other embodiments illustrated hereinafter).

In the second of these preferred embodiments shown in FIG. 7 (embodiment 89), Brewster angle ridges 90 are embossed, cut or molded into the bottom interior of the target container body 79 such that the radiation emanating from the cryogen-immersed target 85 exits to the radiometry device at the Brewster angle and without reflection. Thus, no standing wave or reflected signal exists between the target and the radiometer. If the particular target is designed to accommodate two orthogonal polarizations, the ridges can be oriented at 45 degrees to each of the polarizations. The ridge angles (between each protruding side) should be about 60 degrees such that each polarization sees about 50°.

In one particular tested usage of Brewster ridges 90 formed in container 75 (made of 8#/cu.ft. or of 4#/cu.ft. USComposites urethane foam, for example), with ridges averaging 0.6 inches in height and separation, which would be an insertion loss of 0.01 dB at 22 GHz and 0.013 dB at 30 GHz., temperature enhancements of about 0.3K at 22 GHz and 0.5K at 30 GHz. were measured (for the 8#/cu.ft foam). Using the 4#/cu.ft. urethane foam, about half of these enhancement values are realized (i.e., about 0.15K at 22 GHz and 0.25K at 30 GHz.). These values would be about double for the V-band, or in the vicinity of 60 GHz.

Also shown in FIG. 7, to eliminate condensation of atmospheric moisture (91) on the underside of the target which would induce a large uncertainty in target temperature, blower system (92) flows air through heater system (93) to direct warmed air onto the viewing area on the underside of container 75 to keep the lower surface of the container above the local dew point temperature (while not shown in all cases, the benefits of this feature can be utilized in the other embodiments illustrated herein).

These embodiments enable determination of the blackbody temperature of target 85 very accurately. For instance, in the case of liquid nitrogen, if the local barometric pressure is known to within several millibars, the temperature of liquid nitrogen can be known to within 0.01K around 78 Kelvins.

In either case (and also for the remaining embodiment following hereinafter) other features may be implemented that provide further accuracy benefit. For example, since the polystyrene or other container 75 material is usually not gas tight, leakage of the cryogen may occur. The effects of such leakage of the cryogen are more rapid cooling of the external surface of the container and thus possibly condensing atmospheric water vapor, and a softening of the reflective interface by an unknown amount. Thus it is preferred that a sealant layer 95 be applied at the interior of container 75 to prevent the cryogen from entering any passages or interstitial spaces of the microwave-transparent container 75. An impervious liner such as KAPTON or PTFE (TEFLON) is preferred, though an impervious coating such as spray-in or brush-in DUPONT TE3859 PTFE as a colloid suspension in water or RUSTOLEUM enamel can also be used.

Since the embodiments shown in FIGS. 6 and 7 are, in implementation, wavelength independent, they offer a reference calibration target that is functional and accurate across broad wavelengths using the properties of Fresnel Refraction at the Brewster angle. Container size is selected to fully accommodate the field of view of the radiometer antenna system. In both these and others of the illustrated embodiments, highly reflective baffles 97 may be incorporated (as illustrated in FIG. 9) to ensure that all radiation reaching the radiometer antenna system emanates from the cryogenic target system.

Other embodiments of this invention that eliminate the deleterious effects of the standing wave and the cryogen-container interface in device calibration are shown in FIGS. 8 through 11. These embodiments creating an impedance match between liquid nitrogen 83 surface at target 85 and the standing wave realm. This can be accomplished in a number of ways.

In a third embodiment 99 of this invention shown in FIG. 8 this is accomplished by incorporating a wavelength dependent layer 101 of matching material characterized by n=sqrt(nLN) (i.e., a layer of matching material of the geometric mean of the indices on each side of the interface:

n_{layer}=\sqrt{n_{cryogen}/n_{container}}).

An expanded PTFE sheet can be used, having a density reduced to about ¼ the density of solid PTFE (75-80% air or gas), in a thickness of about 0.050″ for 55 GHz radiometer band or about 0.100″ for the 26 GHz radiometer band, or other quarter wave electrical thicknesses for other wavebands. Electrical thickness is the material thickness foreshortened by the inverse of the index of refraction, or the thickness that contains the same phase thickness as would free space. Other dielectrics of suitable index of refraction and thickness can also be utilized. Dielectrics can be “tuned” to the desired index of refraction by reducing or increasing the effective index through inclusion of air or other dielectric medium in small perforations of grooves of gaps. Such features should be a small fraction of the wavelength of observation. The matching layer should be, in any case, an electrical thickness equal to ¼ the wavelength of interest (lambda). One suitable material to be a match at 27 GHz is Gore GR PTFE consisting of a 1 mm layer and a 1.6 mm layer of n=1.15 (the optimum index is n=1.12).

In a fourth embodiment 103 of this invention shown in FIG. 9, impedance matching is accomplished by forming matching grooves, or corrugations, 105 in the lower surface of the interior of container 75 of ¼ lambda depth for a wavelength dependent application, or odd multiples of ¼ lambda of the lowest waveband of interest. This embossing of grooves, or corrugations, may be in one or two directions.

In a fifth and sixth embodiments 107 and 109 of this invention shown in FIGS. 10 and 11, respectively, the impedance matching mechanism is deployed to deaden the reflection of the other reflecting feature (lens 35/antenna19) through surface 111 of impedance matching grooves or similar features (i.e., using a phase correcting lens 35 with a matching layer of corrugations of ¼ lambda at the geometric mean of the lens material and air in the lower surface of the cryogen container for single waveband—FIG. 10), or impedance matching layer 113 (i.e., an impedance matching layer at lens 35 of dielectric constant equal to the geometric mean of lens and air, electrical thickness equal to ¼ lambda—FIG. 11). These solutions are wavelength dependent.

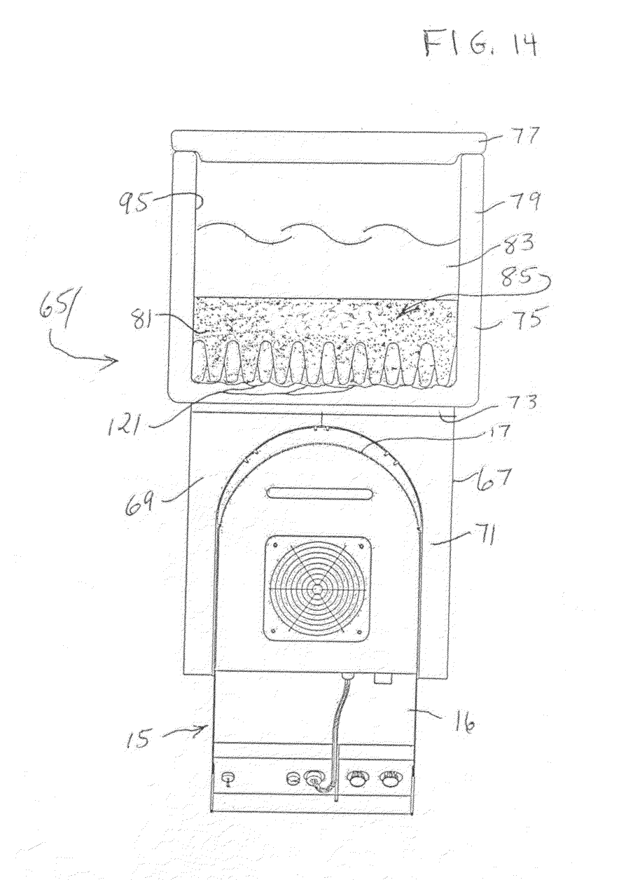

Those aspects of this invention that randomize the standing wave are shown in FIGS. 12 through 14. Embodiment 115 of this invention shown in FIG. 12 utilizes the structuring (size and shape) of blackbody foam material 81 so that it is canted in container 75 thus presenting a canted blackbody target 85 relative to the other reflecting feature (lens 35) to cause reflected energies to manifest through one or a number of wavelengths, depending upon where upon the sloped surface the reflection takes place. In such case, the reflections “walk off” of the target. Alternatively, embodiment 117 of this invention illustrated in FIG. 13 operates to much the same effect by canting container 75 (for example by providing structure at mount 69 or platform 73 of saddle 67 to both cant and secure container 75).

Embodiment 119 of this invention shown in FIG. 14 operates to randomize the phase length between the reflecting features (i.e. the cryogen 83 surface at target 85 and antenna 19/lens 35, so that average resultant phase length is multiples of ½ wavelength of the frequency of interest) by creating features 121, molded into the bottom of container 75 or as inserts thereat, at the cryogen/container interface surface. Preferable these randomized zigzagging ridges at container bottom have a depth of about ½ lambda.

In all three of these cases, the effect is to randomize the phase distance between the target and the antenna system, thus allowing for time-averaging of the resultant target blackbody temperature.

Use of the calibration system of this invention with a typical radiometer device as shown herein begins with mounting of saddle 67 on housing 16 of radiometry device 15 over window 17 of the device as shown in the FIGURES. Container 75 of cryogenic blackbody target calibration system 65 having blackbody foam 81 placed therein with the foam then immersed in liquid nitrogen 83 is placed on platform 73 of saddle 67 (See FIG. 5). While measuring the temperature of the liquid nitrogen, and therefore of the blackbody target 85, to better than several tenths of a degree would be very difficult with thermometer devices, the liquid nitrogen reaches an equilibrium temperature that varies slightly with atmospheric pressure and can be know to within several hundredths of a degree with a barometric pressure measurement. The liquid nitrogen temperature, and therefor the target temperature, in Kelvins can thus be expressed as:

LN2 T(K)=68.23+0/009037×P(millibars).

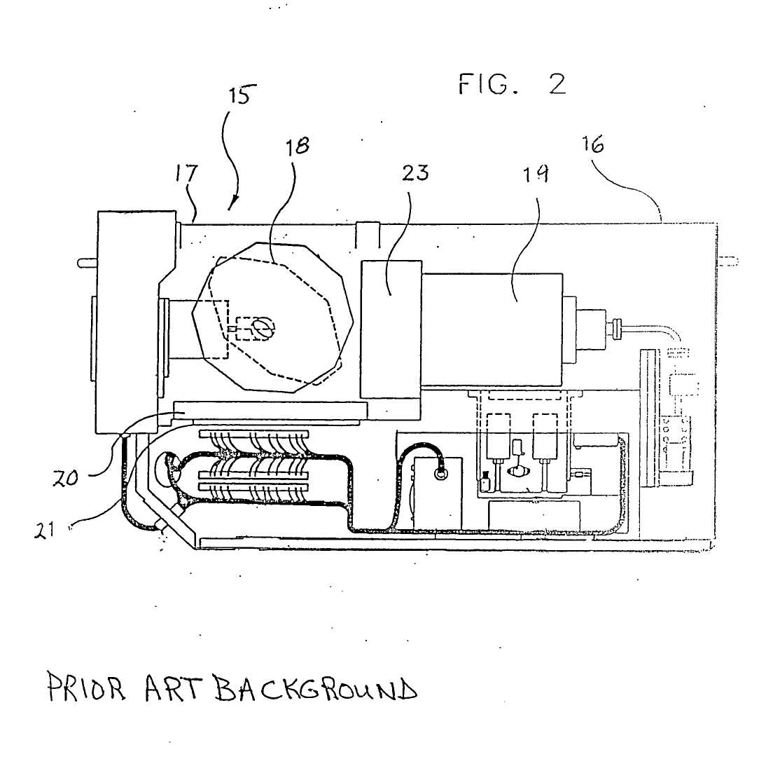

Container 75 is very low loss dielectric material and is therefore transparent to microwave radiation. The radiometer device can therefore look through the polystyrene foam at blackbody target 85 and thereby measure the signal from the target of a precisely known temperature. Radiometry device 15 is controlled to observe calibration target system 65 and blackbody target 20 (FIG. 2) in succession. The difference in video volts with noise diode 41 off and on is then measured, and this measurement converted to temperature by multiplying by the above quotient. Thus the cryogenic target calibration is transferred to the noise diode for long term diode use. This procedure is repeated for all receiver frequencies (and entered into the calibration log file in the connected controlling computer).

As may be appreciated from the foregoing, this invention defeats the standing wave between the reflecting features comprising the surface of the liquid cryogen 83 in the cryogenic target 85 and the reflecting features at device 15 such as reflective surfaces or phase centers in the antenna 19/lens 35. This is accomplished by defeating the reflection at the surface of the cryogen by either effectively angling the surface of cryogen at or near the Brewster angle, or by creating a quarter wave frequency dependent matching surface such as corrugations or a quarter wave layer of dielectric constant that is the square root of the product of the dielectric constants of the cryogen and the container, and ¼ wavelength electrical thickness in said material. This can also be accomplished by causing the phase distance between the reflectors to be random with, for instance, an undulating surface of the cryogen, or angling the cryogen surface relative to the antenna reflector(s).

Moreover, while illustrated in a particular application herein, it should be understood that the calibration systems and methods of this invention can be utilized in any relative orientation of system 65 and radiometry device 15 for viewing of target 85 (i.e, top-down, bottom-up or side viewing of the liquid nitrogen surface could be implemented in any particular application while still achieving the benefits of the invention as may be appreciated by a skilled designer).

What is claimed is:

1. A highly accurate calibration system for a microwave radiometry device having an antenna window and a first reflecting feature thereat, said system comprising:
a target container for holding a blackbody target therein, said target having a second reflecting feature when located in said container, the first reflecting feature and said second reflecting feature presenting a standing wave therebetween when said container is located at the window of the radiometry device for calibration of the device; and
means at one of said container and the radiometry device for effective Brewster angle presentation of radiation emanating from said target to the radiometry device for defeating said standing wave as well as ambient environment reflection from said target.

2. The calibration system of claim 1 wherein the first reflecting feature is a lens, and wherein said means for effective Brewster angle presentation comprises configuring the lens to observe said blackbody target at said Brewster angle at each polarization of electromagnetic radiation of interest.

3. The calibration system of claim 1 wherein said means for effective Brewster angle presentation comprise ridges formed at the interior of said container at a portion thereof upon which said blackbody target is positioned so that radiation emanating from said target exits to the radiometry device at said Brewster angle and substantially without reflection.

4. The calibration system of claim 3 wherein said ridges are oriented at 45° to each of two selected orthogonal polarizations to be accommodated.

5. The calibration system of claim 3 wherein said ridges have ridge angles of about 60° and a selected depth.

6. The calibration system of claim 1 wherein said blackbody target includes a blackbody absorber immersed in liquid nitrogen, said Brewster angle about 50° from orthogonal.

7. The calibration system of claim 1 further comprising an insulating layer of low loss material positioned adjacent a bottom exterior surface of said container so that an air gap is presented between said container side and said insulating layer.

8. The calibration system of claim 1 further comprising a heated air blowing mechanism for moving heated air across a bottom exterior surface of said container.

9. A highly accurate calibration system for a microwave radiometry device having a first reflecting feature thereat, said system comprising:
a target container for holding a blackbody target, said target having a second reflecting feature when located in said container; and
means at one of said container and the radiometry device for defeating a standing wave presented between the first reflecting feature and said second reflecting feature when said container is located at the radiometry device for calibration of the device.

10. The system of claim 9 wherein said means for defeating a standing wave functions wavelength independently.

11. The system of claim 9 wherein said means for defeating standing wave comprises an impedance matching surface of one of an impedance matching material layer and impedance matching grooves.

12. The system of claim 11 wherein said impedance matching material layer is wavelength dependent matching material of n=sqrt(nLN).

13. The system of claim 11 wherein said impedance matching grooves are one of ¼ lambda depth and odd multiples of ¼ lambda of lowest waveband of interest.

14. The system of claim 9 wherein said means for defeating a standing wave are features molded into or inserted at an interior bottom surface of said container having a depth of about ½ lambda.

15. The calibration system of claim 9 further comprising a saddle for mounting said container in a selected orientation relative to the radiometry device.

16. The system of claim 15 wherein one of said saddle or said blackbody target or configured to have a canted presentation when said container is mounted at the radiometry device.

17. The system of claim 9 wherein means for defeating a standing wave include effective Brewster angle presentation of radiation emanating from said target to the radiometry device.

18. The system of claim 9 wherein said container has an interior with a relatively impervious sealant layer thereat.

19. A highly accurate calibration method for microwave radiometry devices comprising the steps of:
holding a blackbody target in a target container;
mounting the container in a selected orientation relative to the radiometry device; and
defeating a standing wave presented between a first reflecting feature at the radiometry device and a second reflecting feature at the blackbody target in the container as well as ambient environment reflection from the blackbody target when the container is mounted at the radiometry device for calibration of the device by effective Brewster angle presentation of radiation emanating from the target to the radiometry device.

20. The calibration method of claim 19 wherein the step of defeating a standing wave includes the step of forming ridges at an interior portion of the container upon which the blackbody target is positioned so that radiation emanating from said target exits to the radiometry device at the Brewster angle and substantially without reflection.

21. The calibration method of claim 20 further comprising forming the ridges with ridge angles of about 60°.

22. The method of claim 19 further comprising the step of relatively imperviously sealing the container interior.

23. The calibration method of claim 19 further comprising at least one of the steps of:
forming an air gap between the container and an insulating layer of low loss material positioned adjacent a bottom exterior surface of the container; and
moving heated air across a bottom exterior surface of the container.

24. The calibration method of claim 19 wherein the step of defeating a standing wave includes configuring the first reflecting feature to observe the blackbody target at the Brewster angle at each polarization of electromagnetic radiation of interest.
